(19) United States
(12) Patent Application Publication
(10) Pub. No.: US 2014/0076877 A1
(43) Pub. Date: Mar. 20, 2014

(54) HEATING APPARATUS, MANUFACTURING METHOD THEREOF, AND HEATING SYSTEM FOR ELECTRIC BLANKET/CARPET

(71) Applicant: IP Investment Co., Ltd., Taichung City (TW)

(72) Inventor: CHEN SAN CHENG, Taichung City (TW)

(73) Assignee: IP Investment Co., Ltd., Taichung City (TW)

(21) Appl. No.: 14/026,981

(22) Filed: Sep. 13, 2013

(30) Foreign Application Priority Data
Sep. 14, 2012 (TW) 101133639

(51) Int. Cl. H05B 3/34

(52) U.S. Cl. CPC H05B 3/342
USPC 219/212; 219/201; 29/610.1

(57) ABSTRACT

A heating apparatus for electric blankets/carpets comprising: a heating element; an adhesive tape material integrally combined and wrapping the heating element; a metal conductor connected to two opposing ends of each of the heating element and the adhesive tape material in a series-parallel manner; and a lead connecting the metal conductor and a power source terminal, wherein a space is defined between the adjacent heating elements. The present invention provides a manufacturing method of a heating apparatus for electric blankets/carpets, comprising the steps of: (a) using a heating element; (b) causing an adhesive tape material to be integrally combined and to wrap the heating element therein; (c) causing a metal conductor to connect to two opposing ends of each of the heating element and the adhesive tape material in a series-parallel manner; and (d) causing a lead to connect the metal conductor and a power source terminal.

### RELATED APPLICATIONS

This application claims priority to Taiwan Application Serial Number 101133639, filed Sep. 14, 2012, which is incorporated by reference herein in its entirety.

### BACKGROUND OF THE UTILITY MODEL

1. Field of the Invention

The present invention relates to a heating apparatus, the manufacturing method thereof and a heating system for electric blankets/carpets, and more particularly, to an electric heating apparatus, the manufacturing method thereof and a heating system for electric blankets/carpets having a heating element (e.g. an electric heating filament, a carbon fiber fabric, a carbon fiber filament etc).

2. Description of the Prior Art

Flexible sheet heaters, which are characterized by flexuosity, light weight and thinness are widely used in clothes, knee pads, waist support, gloves, insoles, earmuffs or waist cushions to keep the user warm.

The structure of a prior art flexible sheet heater mainly comprises: a metal loop formed by performing chemical etching or stamping on a metal sheet; two flexible heat-resistant insulative sheets, in-between which the metal loop is sandwiched; and two power source leads connecting to two ends of the metal loop and extending beyond the two insulative sheets so as to supply an electric current flowing through the metal loop to generate heat. Another prior art flexible sheet heater comprises: a first flexible heat-resistant insulative sheet; a carbon loop printed on the first insulative sheet through a printing technique; and a second flexible heat-resistant insulative sheet disposed above the first flexible heat-resistant insulating sheet with the carbon loop disposed therebetween. Similarly, the heater comprises two power source leads connecting respectively to the two ends of the carbon loop and extending beyond the two insulative sheets. Although the aforementioned two prior art flexible sheet heaters are light and thin and can be slightly bent, they cannot be folded up and thus have a very limited range of application. When they are used to make articles having large areas, such as electric blankets and bedquilts, these articles will be stiff due to the lack of flexibility.

TW Patent No. 1308465 discloses a method of manufacturing a flexible sheet heater by using an electrically conductive fabric as a heat source, comprising the steps of: preparing an electrically conductive fabric and a support member, the support member being formed of a PET film and an acrylic glue adhered to one side of the PET film; joining the PET film and the electrically conductive fabric together by adhering the acrylic glue to one side of the electrically conductive fabric through a pressing process; stamping the electrically conductive fabric to form a heating element having a predetermined loop pattern; bonding a flexible protective sheet made of a thermoplastic material to one side of the heating element opposite to the side to which the PET film is adhered after applying a conducting glue to each of the two ends of the heating element and attaching a respective power source lead thereto; bonding a flexible protective sheet made of a thermoplastic material to the other side of the heating element opposite to the side provided with the protective sheet to complete the flexible heater after removing the PET film. However, the heater has the defect that a separate mold needs to be made to stamp a predetermined loop pattern on an electrically conductive fabric. This leads to a more complicated manufacturing process and significantly increases the cost. Moreover, flexible sheet heaters made using this method are only applicable to small-sized articles, such as clothes, knee pads, waist supports, gloves, insoles, earmuffs or waist cushions, and cannot be used in articles having large areas, such as electric blankets/carpets or bedquilts. Therefore, the method of manufacturing flexible sheet heaters using an electrically conductive fabric as a heat source is defective and needs to be improved.

### SUMMARY OF THE INVENTION

An object of the present invention is to provide a heating apparatus, the manufacturing method thereof, and a heating system for electric blankets/carpets comprising: an electric heating filament, a carbon fiber filament, or a carbon fiber fabric serving as a heating element; a self-adhesive heat-resistant tape material wrapping the heating element; and a metal conductor connected to two opposing ends of each of the heating element and the adhesive tape material in a series-parallel manner to form the heating apparatus, wherein the heating apparatus features excellent flexure and flexibility in conductivity design (in a series-parallel manner) due to a plurality of spaces defined therein and is applicable to articles having large areas such as electric blankets.

A heating apparatus for electric blankets/carpets that achieves the above-mentioned object comprises: a heating element; an adhesive tape material integrally combined and wrapping the heating element therein; a metal conductor connected to two opposing ends of each of the heating element and the adhesive tape material in a series-parallel manner; and a lead connecting the metal conductor and a power source terminal, wherein a space is defined between the adjacent heating elements.

Preferably, the metal conductor is wrapped by the adhesive tape material.

Preferably, the metal conductor is a copper metal.

Preferably, the adhesive tape material is a heat-resistant PET or PI.

Preferably, the adhesive tape material is a self-adhesive material integrated via its adhesion.

A manufacturing method of a heating apparatus for electric blankets/carpets comprises the steps of: (a) using a heating element; (b) causing an adhesive tape material to be integrally combined and to wrap the heating element therein; (c) causing a metal conductor to connect to two opposing ends of each of the heating element and the adhesive tape material in a series-parallel manner; and (d) causing a lead to connect the metal conductor and a power source terminal.

A heating system for electric blankets/carpets comprises: a heating apparatus; a controller electrically connected to the heating apparatus; a relay electrically connected to the controller; and a power source supplying power to the relay.

Preferably, the relay is a pressure-resistant relay featuring an isolation voltage of 3000 volts alternating current (VAC).

Preferably, the controller is a temperature controller.

### BRIEF DESCRIPTION OF THE DRAWINGS

FIG. 1 is a flow chart showing a manufacturing method of a heating apparatus in accordance with the present invention.

FIG. 2A is a schematic representation showing the bonding of a heating element and an adhesive tape material in accordance with a first embodiment.

FIG. 2B is a sectional view taken along line C-C in FIG. 2A.

FIG. 3A is a schematic representation showing the bonding of a heating element and an adhesive tape material in accordance with a second embodiment.

FIG. 3B is a sectional view taken along line D-D in FIG. 3A.

FIG. 4 is a sectional view showing the bonding of a heating element and an adhesive tape material in accordance with a third embodiment.

FIG. 5 is a sectional view showing the bonding of a heating element and an adhesive tape material in accordance with a fourth embodiment.

FIG. 6 is a schematic representation showing the formation of the heating apparatus by bonding the metal conductors, the heating elements and the adhesive tape material.

FIG. 7 is a block diagram showing a heating system of the present invention.

### DETAILED DESCRIPTION OF THE PREFERRED EMBODIMENTS

While this invention will be fully described with preferred embodiments and appended drawings, it is to be understood beforehand that those skilled in the art can make modification to the invention described herein and attain the same effect, and that the description below is a general representation to those skilled in the art and is not intended to limit the scope of the present invention.

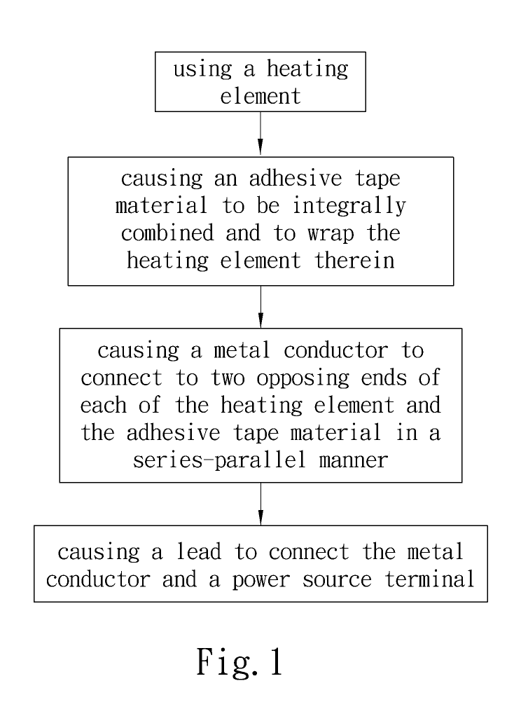

FIG. 1 is a flow chart showing a manufacturing method of a heating apparatus for electric blankets/carpets of the present invention comprising the following steps.

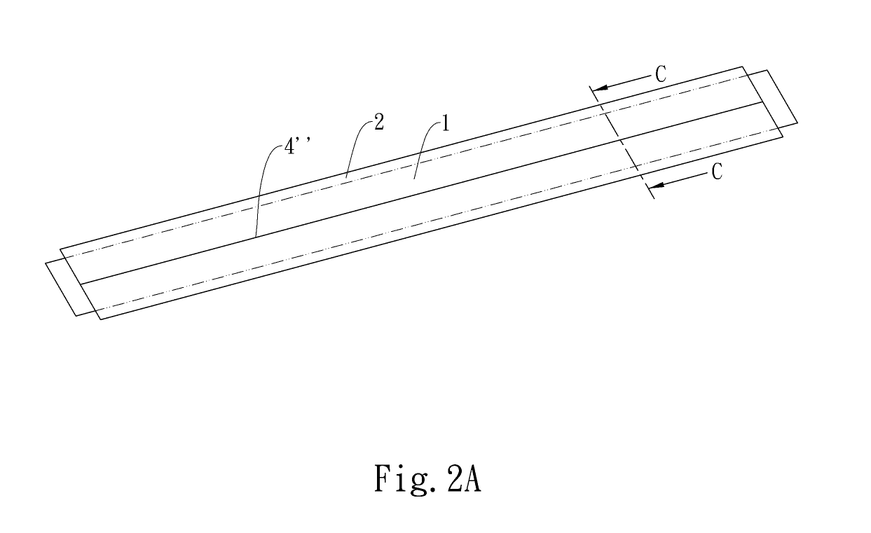

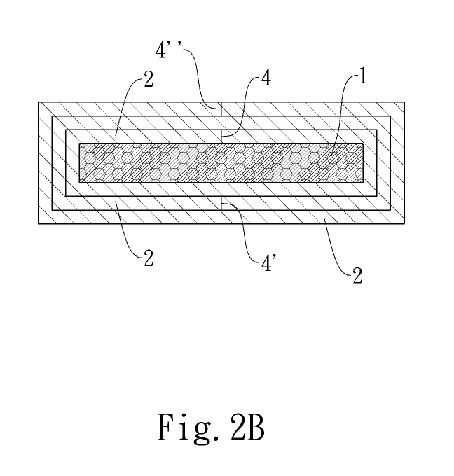

At Step 1: a heating element 1 is used. FIG. 2A is a schematic representation showing the bonding of the heating element and the adhesive tape material. In this embodiment, the present invention uses an accessible material-the flexible heating element 1, such as an electric heating filament, a carbon fiber fabric, or a carbon fiber filament, characterized in that the heating element 1 generates heat when an electric current passes therethrough.

At Step 2, an adhesive tape material 2 is caused to be integrally combined and to wrap the heating element 1 therein. Referring to FIG. 2A, an adhesive tape material 2 can be a PET or PI and heat-resistant. The adhesive tape material 2 is a self-adhesive material which is integrally combined via its adhesion. There are four embodiments of wrapping the heating element 1 with the adhesive tape material 2, as will be detailed below.

The first embodiment is illustrated in FIGS. 2A and 2B. FIG. 2A is a schematic representation showing the bonding of the heating element and the adhesive tape material; FIG. 2B is a sectional view taken along line C-C in FIG. 2A. The adhesive tape material 2 wraps the heating element 1 therein, wherein a joint 4 where an innermost first layer of the adhesive tape material 2 bonds to itself is at the upper side of the heating element 1, a joint 4′ where an intermediate second layer of the adhesive tape material 2 bonds to itself is at the lower side of the heating element 1, and a joint 4″ where an outermost third layer of the adhesive tape material 2 bonds to itself is at the upper side of the heating element 1. It is worth mentioning that the joints 4, 4′ and 4″ where the adhesive tape material 2 bonds to itself can be arranged at the left side or the right side of the heating element 1 in an alternating manner. Moreover, the heating element 1 is to be wrapped by at least three layers of the adhesive tape material 2.

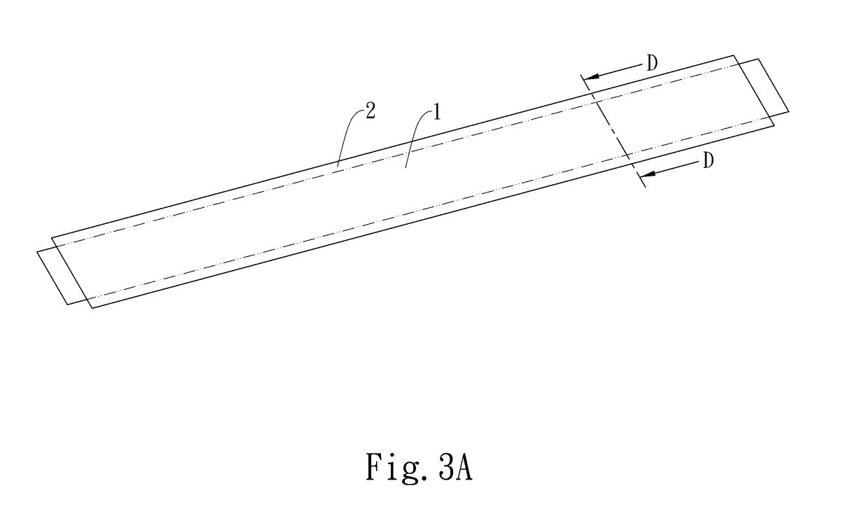

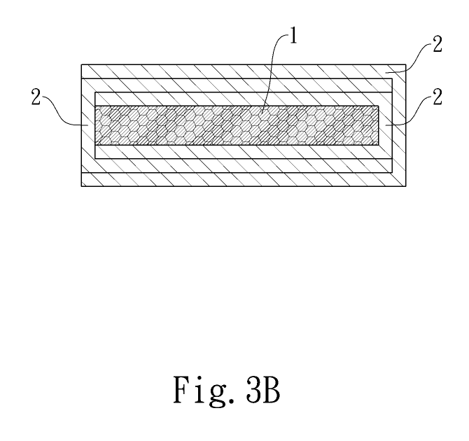

The second embodiment is illustrated in FIGS. 3A and 3B. FIG. 3A is a schematic representation showing the bonding of the heating element and the adhesive tape material; FIG. 3B is a sectional view taken along line D-D of FIG. 3A. The adhesive tape material 2 wraps the heating element 1 therein, wherein an innermost first layer of the adhesive tape material 2 wraps the heating element 1 in an inverted C-shaped manner, an intermediate second layer of the adhesive tape material 2 wraps the first layer of the adhesive tape material 2 in a C-shaped manner, and an outermost third layer of the adhesive tape material 2 wraps the intermediate second layer of the adhesive tape material 2 in a inverted C-shaped manner. It is worth mentioning that the heating element 1 is to be wrapped by at least three layers of the adhesive tape material 2.

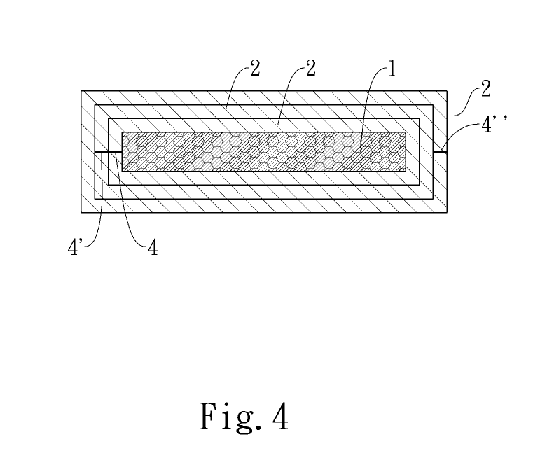

The third embodiment is illustrated in FIG. 4. FIG. 4 is a sectional view showing the bonding of the heating element and the adhesive tape material. The adhesive tape material 2 wraps the heating element 1 therein, wherein the joints 4, 4′, and 4″ where the adhesive tape material 2 bonds to itself are arranged at the left side or the right side of the heating element 1 in an alternating manner. This is a variation of the first embodiment. It is worth mentioning that the heating element 1 is to be wrapped by at least three layers of the adhesive tape material 2.

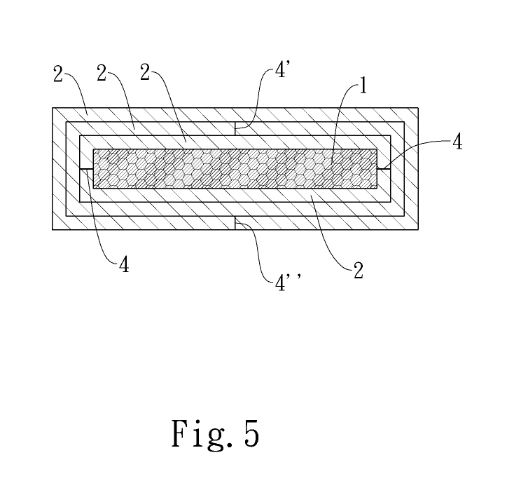

The fourth embodiment is illustrated in FIG. 5. FIG. 5 is a sectional view showing the bonding of the heating element and the adhesive tape material. The adhesive tape material 2 wraps the heating element 1 therein, wherein an innermost first layer of the adhesive tape material 2 wraps the heating element 1 in an U-shaped manner and an inverted U-shaped manner and results in the formation of two joints 4, an intermediate second layer of the adhesive tape material 2 wraps the first layer of the adhesive tape material 2 and results in the formation a joint 4′, and an outermost third layer of the adhesive tape material 2 wraps the intermediate second layer of the adhesive tape material 2 and results in the formation a joint 4″. The joints 4, 4′, and 4″ of the adhesive tape material 2 are located at the upper side, the lower side, the left side and the right side of the heating element 1 in an alternating manner. This is another variation of the first embodiment. It is worth mentioning that the heating element 1 is to be wrapped by at least three layers of the adhesive tape material 2.

A variety of other embodiments may be contemplated according to needs, and these embodiments may be any combination of the first through fourth embodiments.

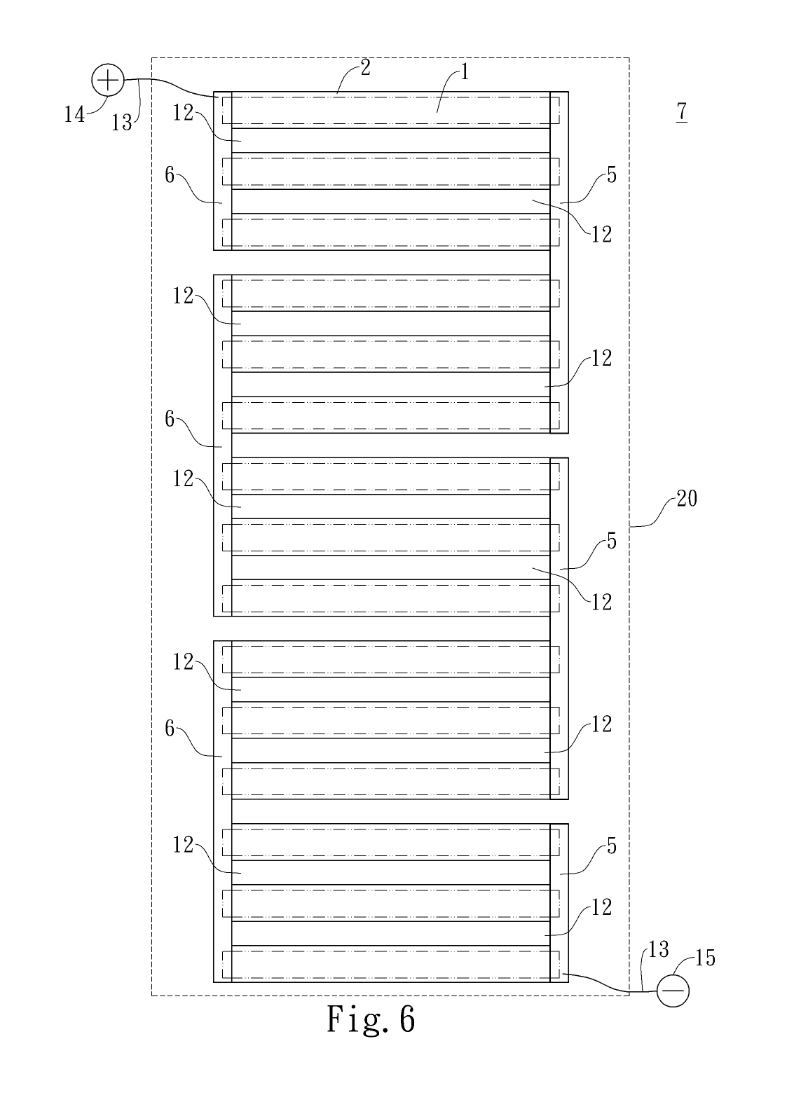

At Step 3, a metal conductor 5 and a metal conductor 6 are connected respectively to two opposing ends of each of the heating element 1 and the adhesive tape material 2. FIG. 6 is a schematic representation showing the formation of a heating apparatus by bonding the metal conductors, the heating element and the adhesive tape material. A plurality of the heating elements 1 and the adhesive tape material 2 are arranged in parallel, and a plurality of the metal conductors 5 and 6 are connected respectively to two opposing ends (i.e. the left end and the right end) of each of the heating element 1 and the adhesive tape material 2 in a series-parallel manner and thereby to form the heating apparatus 7 of the present invention, wherein the plurality of the metal conductors 5 and 6 are connected with the heating elements 1.

At Step 4, a lead 13 is caused to connect the metal conductors 5, 6 and an anode power source terminal 14 and a cathode power source terminal 15. The metal conductors 6 are connected to the anode power source terminal 14 via the lead 13, and the metal conductors 5 are connected to the cathode power source terminal 15 via the lead 13. The heating apparatus 7 can generate heat by supplying an electric current to the anode power source terminal 14 and the cathode power source terminal 15.

Referring to FIG. 6, the heating apparatus 7 of the present invention comprises a plurality of the heating elements 1. In this embodiment, it is optimum that the heating elements 1 are arranged in parallel with respect to each other and a space 12 is defined between the adjacent heating elements, that the adhesive tape material 2 is integrally combined and wraps the heating element 1, and that a plurality of the metal conductors 5, 6 are arranged respectively at two opposing ends of each of the heating element 1 and the adhesive tape material 2 to serve as power source terminals. It is worth mentioning that the metal conductors 5, 6 are copper metal and can be optionally wrapped with the adhesive tape material 2 to prevent leakage of electricity. When an electric current is directed into the metal conductors 5, 6, the electric current will flow through the heating element 1 and causes the heating element 1 to generate heat. When the heating apparatus 7 of the present invention employs the configuration of FIG. 6 and is wrapped in a fabric product 20 (e.g. an electric blanket/carpet having a large area), the weight can be significantly reduced and the softness can be increased due to the plurality of spaces 12 (the arrangement of the metal conductors 5, 6 in a series-parallel manner can increase the flexibility in conductivity design) so that the electric blanket/carpet is still light and soft.

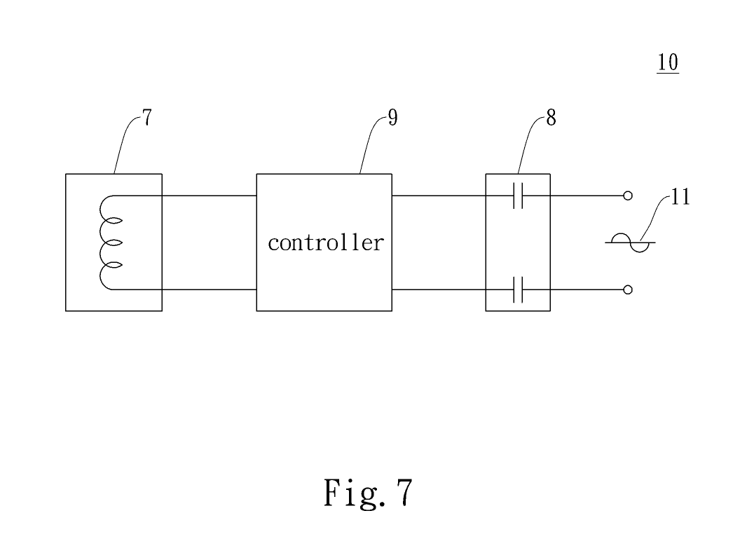

FIG. 7 is a block diagram showing a heating system of the present invention. Please also refer to FIG. 6. The heating system 10 of the present invention comprises: the heating apparatus 7 formed by bonding the metal conductors 5, 6, the heating element 1 and the adhesive tape material 2; a controller 9 electrically connected to the heating apparatus 7; a relay 8 electrically connected to the controller 9; and a power source 11 supplying power to the relay 8. Preferably, the relay 8 is a pressure-resistant relay featuring an isolation voltage of at least 2500 VAC. Preferably, it features an isolation voltage of 3000 VAC. The controller 9 is a temperature controller that can be used to adjust the temperature of heat generated by the heating apparatus 7 of the present invention.

The safety specifications for the present invention are as follows: 1. when the heating element is only wrapped with a layer of the adhesive tape material, the thickness of the layer of the adhesive tape material is required to be at least above 1 m/m; when the heating element is wrapped with more than three layers of the adhesive tape material, there is no limitation on the thickness of the layer of the adhesive tape material. 2. For a 110 VAC power source, a creepage distance (CR) of the adhesive tape material is required to be at least above 6 mm. For a 220 VAC power source, a creepage distance (CR) of the adhesive tape material is required to be at least above 8 mm.

The heating apparatus of the present invention has the following advantages:

1. The metal conductors arranged at two opposing ends of each of the heating element and the adhesive tape material in a series-parallel manner can be used to adjust the overall output power so that the flexibility in conductivity design is increased without being limited by the material's properties.

2. The present invention characterized by light weight, thinness and flexibility has a wide range of application on (large-sized) articles having large areas, such as electric blanks/carpets, to provide warmth to the user.

While this invention has been described by way of preferred embodiments, it is to be understood that this invention is not limited hereto, and that various changes and alterations can be made herein by those skilled in the art without departing from the spirit and scope of this invention as defined by the appended claims.

What is claimed is:

1. A heating apparatus for electric blankets/carpets, comprising:
a heating element;
an adhesive tape material integrally combined and wrapping the heating element;
a metal conductor connected to two opposing ends of each of the heating element and the adhesive tape material in a series-parallel manner; and
a lead connecting the metal conductor and a power source terminal;
wherein a space is defined between the adjacent heating elements.

2. The heating apparatus for electric blankets/carpets according to claim 1, wherein the metal conductor is wrapped with the adhesive tape material.

3. The heating apparatus for electric blankets/carpets according to claim 1, wherein the metal conductor is a copper metal.

4. The heating apparatus for electric blankets/carpets according to claim 1, wherein the adhesive tape material is a heat-resistant PET or PI.

5. The heating apparatus for electric blankets/carpets according to claim 1, wherein the adhesive tape material is a self-adhesive material integrally combined via its adhesion.

6. The heating apparatus for electric blankets/carpets according to claim 2, wherein the adhesive tape material is a heat-resistant PET or PI.

7. The heating apparatus for electric blankets/carpets according to claim 2, wherein the adhesive tape material is a self-adhesive material integrally combined via its adhesion.

8. A manufacturing method of a heating apparatus for electric blankets/carpets, comprising the steps of:
(a) using a heating element;
(b) causing an adhesive tape material to be integrally combined and to wrap the heating element therein;
(c) causing a metal conductor to connect to two opposing ends of each of the heating element and the adhesive tape material in a series-parallel manner; and
(d) causing a lead to connect the metal conductor and a power source terminal.

9. A heating system for electric blankets/carpets, comprising:
a heating apparatus of claim 1;
a controller electrically connected to the heating apparatus;
a relay electrically connected to the controller; and
a power source supplying power to the relay.

10. The heating system for electric blankets/carpets according to claim 9, wherein the relay is a pressure-resistant relay and has an isolation voltage of 3000 VAC.

11. The heating system for electric blankets/carpets according to claim 9, wherein the controller is a temperature controller.
